(19) United States
(12) Patent Application Publication
(10) Pub. No.: US 2007/0294588 A1
(43) Pub. Date: Dec. 20, 2007

(54) Performing a diagnostic on a block of memory associated with a correctable read error

(76) Inventor: Richard L. Coulson, Portland, OR (US)

Correspondence Address: TROP PRUNER & HU, PC, 1616 S. VOSS ROAD, SUITE 750, HOUSTON, TX, 77057-2631, US

(21) Appl. No.: 11/430,361

(22) Filed: May 9, 2006

(51) Int. Cl. G06F 11/00

(52) U.S. Cl. 714/42

(57) ABSTRACT

In one embodiment, a block of memory associated with a read error is assigned to a suspect state to wait until there is processing capacity available to perform a diagnostic. If there is processing capacity available to perform the diagnostic, the block of memory can be assigned to a diagnostic state. Other embodiments are described and claimed.

### BACKGROUND

Embodiments of the present invention relate to storage technologies, and more particularly to performing a diagnostic on a block of memory associated with a corrected read error.

The processing capabilities of new generations of computer systems continue to increase. With these capabilities is a greater need for storage capacity and for efficient ways to retrieve data to avoid slowing down the process of useful work in a processor of a system. Accordingly, various memory technologies have been proposed for use in a system to improve data capacity and to accommodate greater bandwidth for data retrieval. Memory technologies can include non-volatile memories such as semiconductor memories, ferroelectric polymer memories (FPM), magnetic memories, phase change memories, and other memories that have been developed or proposed for use in computer systems.

Certain of these memory technologies, such as semiconductor memories including flash-based technologies, may be arranged in a block-oriented manner. That is, a memory may be formed of a number of blocks. In certain memory technologies, before data can be written to a block, the block can first be placed in a known state, i.e., an erased state. One such memory technology arranged in blocks is a NAND-based flash technology. While such memories are suitable for write and read operations, errors can occur during these read and write operations as well as during an erase operation to ready a block for writing. Such failures can lead to a loss of data.

### BRIEF DESCRIPTION OF THE DRAWINGS

FIG. 1 is a flow diagram of a method in accordance with one embodiment of the present invention.

FIG. 2 is a more detailed flow diagram of a method in accordance with one embodiment of the present invention.

FIG. 3 is a state diagram representing the states of memory blocks in one embodiment of the present invention.

FIG. 4 is a block diagram of a storage device in accordance with one embodiment of the present invention.

FIG. 5 is a block diagram of a computer system in which embodiments of the invention may be used.

### DETAILED DESCRIPTION

In various embodiments, techniques may be used to determine if a block of memory may continue to be used to store data after a read error is associated with the block of memory. The techniques can be used to prevent a reduction in the data storage capacity of the memory. The techniques can be used to reduce the danger to the integrity of data stored in a block of memory by extending an error correction coding beyond its capabilities.

Embodiments may be implemented in a NAND-based non-volatile memory technology, although the scope of the present invention is not limited in this regard. Such NAND-based memory devices may be used as storage products for various system types. For example, in some embodiments a solid state disk may be formed using the NAND-based memory technology. In other embodiments, a disk cache or other cache memory may be implemented using the NAND-based memory technology.

The non-volatile memory array may include a number of segments arranged as blocks of memory. These blocks may be formed of a plurality of pages of memory.

Blocks of memory can be assigned to a state. In one embodiment, the state of a block of memory can be a bad state, a good state, a suspect state, or a diagnostic state. In one embodiment, a block of memory in a bad state is not used to store data. A block of memory in a good state can be used to store data in pages of memory within the block of memory.

In one embodiment, a correctable read error can result in a block of memory being assigned to a suspect state. The block of memory can wait in this state until a diagnostic can be performed. In one embodiment, memory blocks in a suspect state are not used to store data. A block of memory in a diagnostic state can be subjected to read, write and erase operations as well as special diagnostic commands that determine the suitability of the block of memory for data storage. The special diagnostic commands may operate on portions of the block of memory, or may do some operations in parallel on the entire block of memory at once. For example, the special diagnostic commands may add a noise offset into the sensing circuit for the block of memory in order to reduce the read sensing signal and expose weak bits. The special diagnostic commands may for example use weak write signals and then read the data written to see if the data can be recovered. The embodiments are not limited to the examples of the special diagnostic commands and other special diagnostic commands may be used.

A correctable read error can result from factors that are no longer present, such as temperatures above a specified level, which can cause data retention errors. A diagnostic can determine the state for a block of memory associated with a correctable read error. The use of a block of memory having a correctable read error without performing a diagnostic to determine if the block of memory belongs in a good state or a bad state may result in a loss of capacity or overextending the error correction coding of a system. For example, in one embodiment, a loss of capacity may occur by assigning a block of memory to a bad state that prevents the block of memory from being used to store data. If a diagnostic determines instead that the block of memory is suitable for data storage, no capacity may be lost. Overextending the error correction coding may occur in one embodiment, if a block of memory is not suitable for data storage but remains in a good state causing the error correction coding to correct more errors than its capabilities allow.

Controllers that can implement a diagnostic may be device drivers for a personal computer or a processor with an XScale® or ARM® architecture available from Intel Corporation of Santa Clara, Calif.

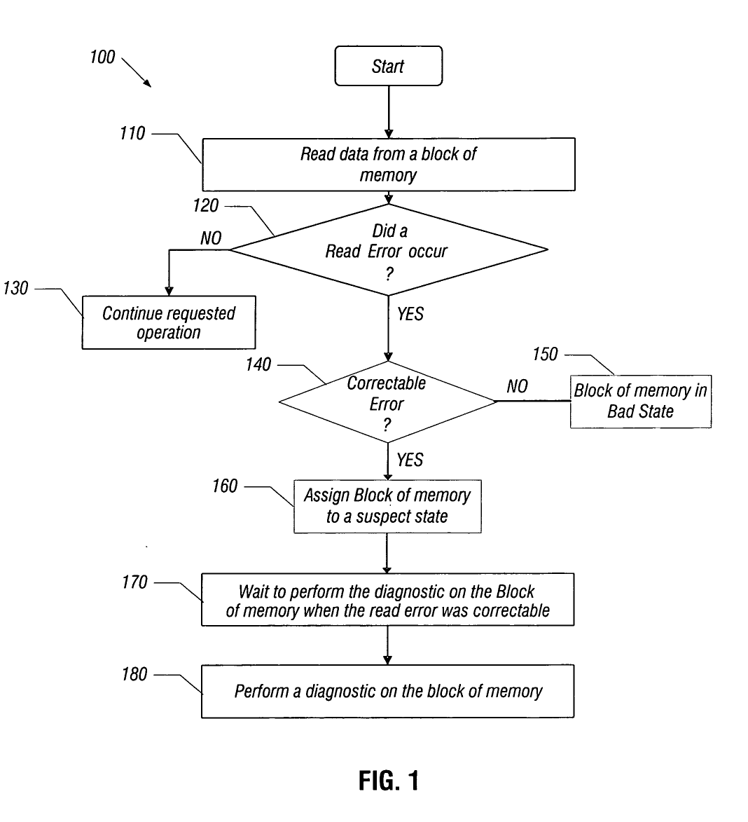

FIG. 1 is a flow diagram of a method in accordance with one embodiment of the present invention. Method 100 may be used to determine if a block of data can be assigned to a good state or a bad state. In some implementations, method 100 may be performed by a controller or driver associated with the storage device although the scope of the present invention is not so limited.

Data can first be read from a block of memory (block 110). An analysis of the data read from the block of memory can determine if an error has occurred (diamond 120). If no error has occurred, the requested read operation can be continued (block 130). If an error has occurred, it can be determined if the error is correctable using the error correction coding (diamond 140). A block of memory associated with an uncorrectable read error can be assigned to a bad state (block 150).

If error-correction coding associated with the data was used to correct a read error, the block of memory can be assigned to a suspect state (block 160).

The data read from the block of memory associated with the correctable read error can be corrected and written into another block of memory.

In the suspect state, the block of memory can wait to have a diagnostic performed on the pages within the block of memory (block 170). A diagnostic can be performed if there is processing capacity available to perform the diagnostic (block 180). Performing a diagnostic can use processing capacity of a system and if a diagnostic is performed without available processing capacity other operations for example read or write operations may be affected. In one embodiment, the processing capacity may be determined by determining if a processor is idle, how long a processor has been idle or a processor's utilization for processes other than performing a diagnostic. The amount of time required to perform a diagnostic may change based on the number of errors which need correction, the location of the errors in the block of memory or other factors.

A diagnostic performed on a block of memory that is associated with a correctable read error can determine how many permanent read errors and weak bits will result from data being stored in pages of the block of memory.

A reduction in capacity can occur if a block of memory associated with a correctable read error is assigned to a bad state without performance of a diagnostic. The use of a diagnostic can balance the effects of a reduction in capacity against the danger to the integrity of the stored data by the overextension of the error correction coding.

A diagnostic may erase the block of memory or write known data patterns to the block of memory to check the memory operation. The results of the diagnostic can be used to determine if the block of memory is assigned to the bad state or the good state for reuse in storing data.

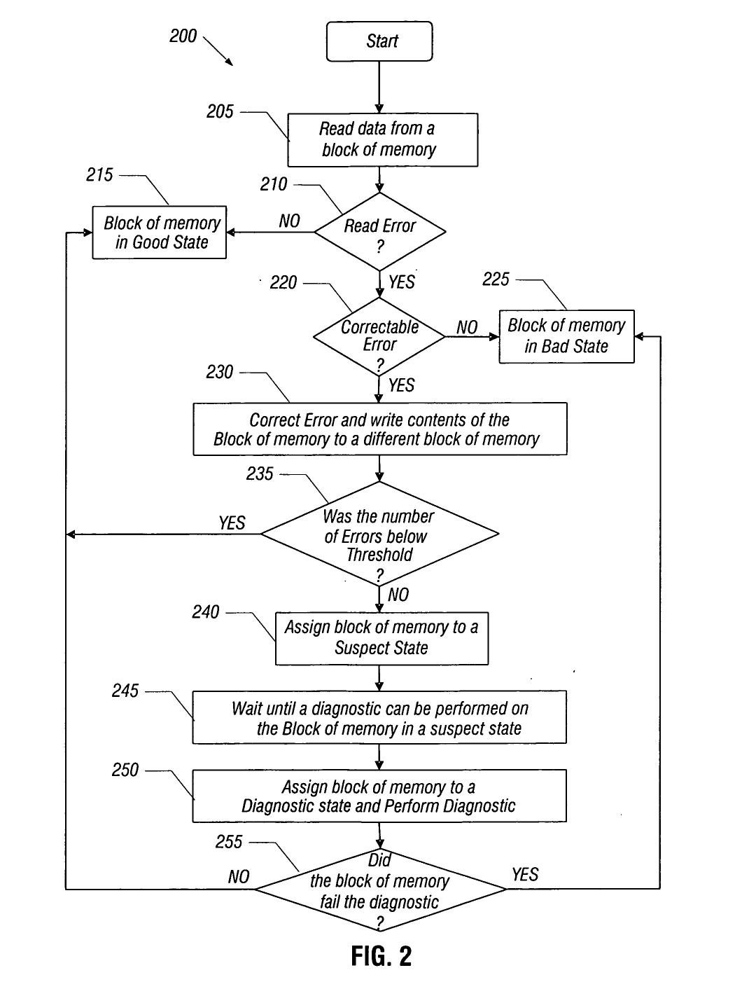

FIG. 2 is a more detailed flow diagram of a method in accordance with an embodiment of the present invention.

As shown in FIG. 2, method 200, which may also be performed by a controller or driver of the non-volatile memory device, may begin by a reading of data from a block of memory (block 205). The data read from the block of memory can be checked for errors (diamond 210). If there is no read error at diamond 210, the block of memory can be assigned to or maintained in a good state (block 215).

Read errors can occur when data is read from a block of memory. Read errors can be caused by permanent conditions associated with bits in a memory, such as an open, a short, or an oxide defect within the memory. Weak bits can result in intermittent read error conditions. For example, temperature may cause the bit to malfunction. Sometimes when a bit causes a read error, if the block of memory is erased and rewritten, the bit can perform within the operating conditions for storing data.

If an error exists in the data read from the data block, it can be determined whether error-correction coding associated with the data can be used to correct the error in the data read from the block (diamond 220). If the data read from the block of memory is not correctable, the block of memory can be placed in a bad state (block 225). If it is determined that the read error was correctable (diamond 220), the error-correction coding can be used to correct the data read from the block of memory and write the contents of the block of memory to a different block of memory (block 230).

In one embodiment, the number of errors corrected by the error-correction code can be compared to a threshold number (diamond 235). If the number of errors is below the threshold (diamond 235), the block of memory can be assigned to a good state (block 215). For example, the threshold may be set at 0, in which case any correctable read error can cause a block of data to go through a diagnostic state; or the threshold may be set so that a correctable read error of a couple of bits may result in the data block being assigned to a good state.

In one embodiment, the determination of whether a block of memory may be assigned to a good state, a bad state, or a suspect state can be based on the number of correctable read errors. For example, if one bit required correction out of 512 bytes, and the threshold level was set at three bits per 512 bytes, the block of memory may remain assigned to a good state after the block has been erased. If the number of bits corrected was four and the threshold level was set at three bits, the block of memory may be assigned to a suspect state. In some embodiments, there can be two threshold levels, an upper level and a lower level. If the number of correctable read errors is equal to or below a lower threshold level, the block of memory can be assigned to a good state. If the number of correctable read errors is equal to or above a higher threshold level, the block of memory can be assigned to a bad state. If the number of read errors is between the two thresholds, the block of memory can be assigned to a suspect state. A threshold of zero can result in memory blocks associated with a correctable read error being assigned to a suspect state, in one embodiment.

A block of memory can be assigned to a suspect state (block 240) if the number of errors was above the threshold. A block of memory in a suspect state can wait until processing capacity is available for performing a diagnostic (block 245). A diagnostic can be performed once a block of memory has entered the diagnostic state (block 250) from the suspect state. In one embodiment, the block of memory can either pass or fail the diagnostic (diamond 255). The block of memory can be assigned to the bad state (block 225) if it fails the diagnostic (diamond 255) or the good state (block 215) if it passes the diagnostic (diamond 255).

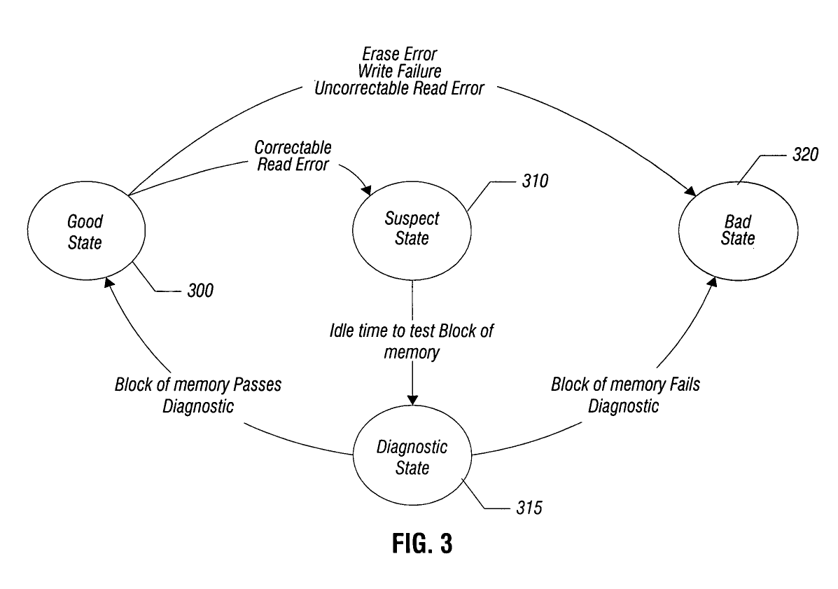

FIG. 3 depicts a state diagram of possible states for a block of memory in one embodiment of the invention. In one embodiment, a block of memory can be in a good state 300, a suspect state 310, a diagnostic state 315, or a bad state 320.

In one embodiment, a block of memory can be considered unsuitable for storing data if an erase operation fails on the block of memory, if a write operation fails to write data to a page within the block of memory, or if a read operation from a block of memory generates an error that is not correctable by the error correction coding. No data is lost, in one embodiment, because the data can be written to an alternate page in another block of memory.

The block of memory can be changed from a good state 300 to a bad state 320 if an erase error, a write failure, or an uncorrectable read error results from the execution of an operation. The block of memory can be moved from the good state 300 to the suspect state 310 if it outputs data causing a correctable read error.

The block of memory can wait in the suspect state 310 for an opportunity to have a diagnostic performed. In one embodiment, a block of memory cannot be written to or read from if in the suspect state 310. Diagnostic data in one embodiment may be written to a block of memory in the suspect state 310.

A block of memory in a suspect state 310 can be moved to a diagnostic state 315 if an opportunity exists for a diagnostic to be performed. Various tests can be performed in the diagnostic state 315, such as writing data of a known pattern to the block of memory. If the block of memory passes the diagnostic performed in the diagnostic state, the block of memory can be moved from the diagnostic state 315 to the good state 300. If the block of memory fails the diagnostic in the diagnostic state 315, the block of memory can be moved to the bad state 320. Special diagnostic commands may be implemented in the non-volatile memory and these commands may be used for tests in addition to tests that perform read, write and erase operations.

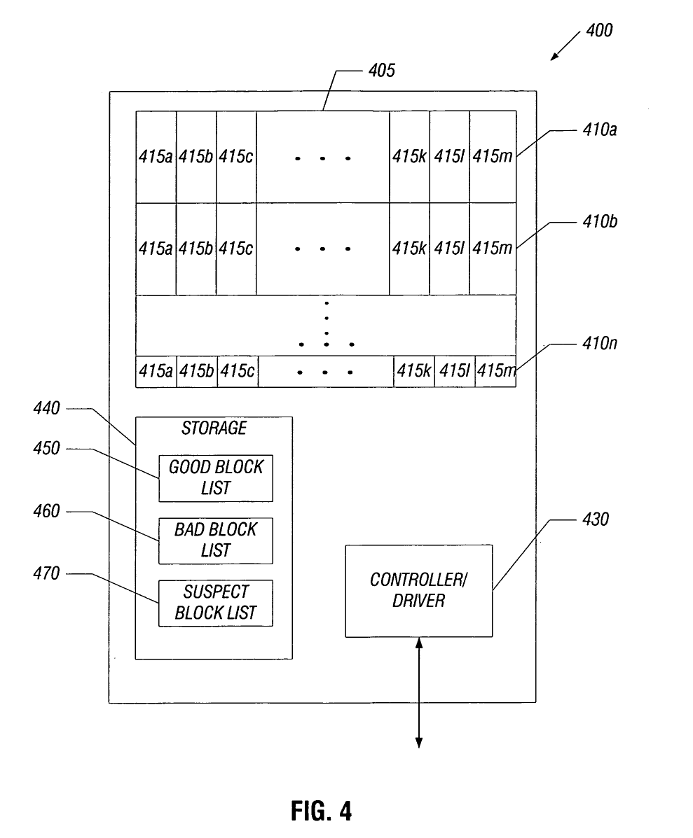

FIG. 4 is a block diagram of a storage device in accordance with one embodiment of the present invention. As shown in FIG. 4, storage device 400 may be a mass-storage device or other storage device for use in a system.

As shown in FIG. 4, storage device 400 may include a non-volatile memory array 405 formed of a plurality of individual blocks of memory 410a-410m (generically block 410). Each block of memory 410 may be formed of a plurality of individual pages 415a-415m (generically page 415). While the scope of the present invention is not limited in this regard, each block of memory 410 may be formed of 64 pages.

While the form of non-volatile memory array 405 may vary in some embodiments, a NAND-based technology may be used. Data can be received by the storage device 400 through a controller 430. The controller can be connected to the memory array, allowing read and write operations to occur within the memory array 405. If the controller 430 receives data to be written to the memory array 405, the data can be written to a page 415 within a block of memory 410. If the controller 430 receives a command to read data from the memory array 405, the data can be read from a page 415 within a block of memory 410. If the controller 430 receives a command to perform an erase operation, the block of memory 410 including pages 415a-415m can be erased.

The controller 430 can be connected to a storage 440. The storage 440 can include a good-block list 450, a bad-block list 460, and a suspect-block list 470. If a controller 430 receives a command that generates an erase error, a write failure, or an uncorrectable read error in a block of memory 410, the controller can move an identifier such as an address of the block or another distinguishing feature of the block associated with the erase error, write failure, or uncorrectable read error from the good-block list 450 to the bad-block list 460.

The state of a block of memory can be assigned by the controller or driver. Changing the number of states that a block of memory can be assigned to can be implemented by changing the firmware of the controller. For example, a controller can assign blocks of memory to a bad state or a good state. A change in the firmware of the controller can add a suspect state and a diagnostic state. The addition of states to a controller or driver can be implemented by changing the circuit for the controller. The change in the circuit can be implemented in a semiconductor, such as silicon.

If the controller 430 receives a command that results in a correctable read error, the corrected data from one block of memory can be stored in another block of memory. The read errors can relate to individual pages in a block of memory. If a page has a read error with the number of bits above a threshold level then the data can be moved to a page of a known good block. The pages in the block of memory without read errors can be copied to new locations in known good blocks of memory. The data copied from the block of memory may be copied to one good block of memory or multiple good blocks of memory. For example, if a command to read data from block 410a generates a correctable read error, the data read from block 410a and corrected by error-correction coding can be stored in another block that has an identifier in the good-block list 450. For example, if block 410b has an identifier in the good-block list 450, the contents of block 410a can be written to block 410b. The identifier for block 410a can then be moved by the controller 430 from the good-block list 450 to the suspect block list 470.

A diagnostic can be performed by writing known data patterns to the pages 415 within the block 410a in one embodiment if the controller 430 determines that there is processing capacity available to perform a diagnostic. The controller can also perform other diagnostics. After the controller has performed the diagnostic, the identifier of the block can be moved to the good-block list 450 or the bad-block list 460. In some embodiments, the controller 430 can begin performing tests on blocks of memory 410 before completing the tests on other blocks of memory 410.

Using embodiments of the present invention, a non-volatile memory device can determine if a block of memory that generated a correctable read error will continue to generate read errors or if the correctable read error was a one-time event.

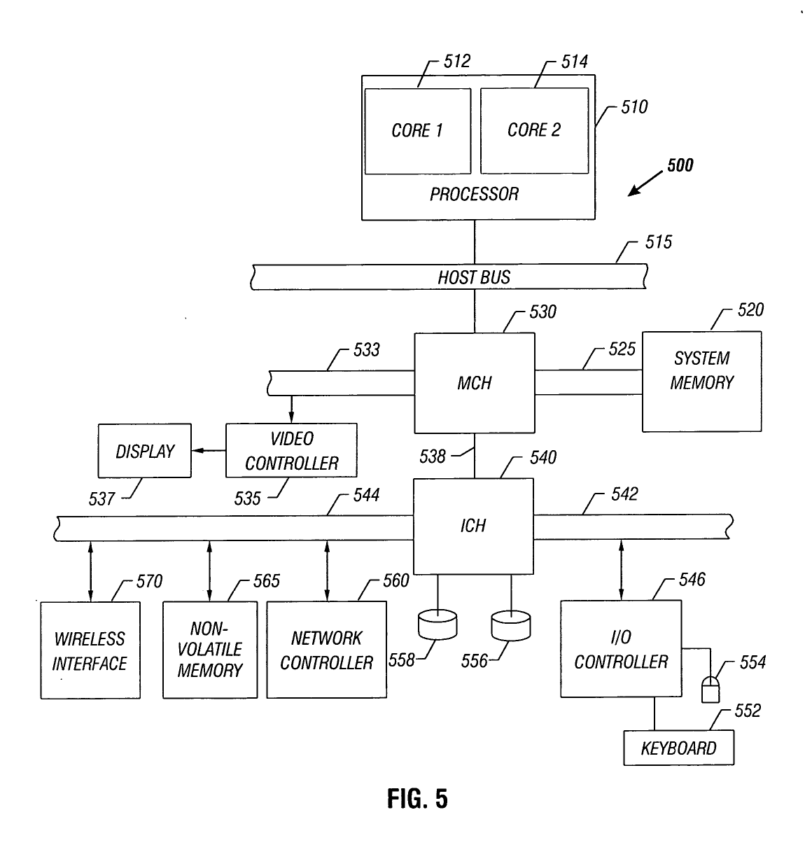

FIG. 5 is a block diagram of a computer system 500 in which embodiments of the invention may be used. As used herein, the term “computer system” may refer to any type of processor-based system, such as a notebook computer, a server computer, a laptop computer, a desktop computer, or the like. In one embodiment, computer system 500 includes a processor 510, which may be a multicore processor including a first core 512 and a second core 514. Processor 510 may be coupled over a host bus 515 to a memory controller hub (MCH) 530 in one embodiment, which may be coupled to a system memory 520 (e.g., a DRAM) via a memory bus 525. MCH 530 may also be coupled over a bus 533 to a video controller 535, which may be coupled to a display 537.

MCH 530 may also be coupled (e.g., via a hub link 538) to an input/output (I/O) controller hub (ICH) 540 that is coupled to a first bus 542 and a second bus 544. First bus 542 may be coupled to an I/O controller 546 that controls access to one or more I/O devices. As shown in FIG. 5, these devices may include in one embodiment input devices, such as a keyboard 552 and a mouse 554. ICH 540 may also be coupled to, for example, multiple hard disk drives 556 and 558, as shown in FIG. 5. Such drives may be two drives of a redundant array of individual disks (RAID) subsystem, for example. Other storage media and components may also be included in the system. Instead of drives 556 and 558, one or more solid state disks may be present in accordance with an embodiment of the present invention. Second bus 544 may also be coupled to various components including, for example, a network controller 560 that is coupled to a network port (not shown). A wireless interface 570 may be coupled to second bus 544. Wireless interface 570 may include an antenna, such as a dipole antenna and may be adapted to communicate wirelessly between system 500 and a remote device via a wireless protocol.

A non-volatile memory 565 can be a non-volatile memory including a controller in accordance with an embodiment of the present invention. The non-volatile memory 565 may be coupled to second bus 544. Non-volatile memory 565 may act as a disk cache between disk drives 556 and 558 and processor 510. Non-volatile memory 556 may take the place of disk drives 556 and 558. In some embodiments, a solid state disk in accordance with an embodiment of the present invention may be coupled to system 500 via a Serial-Advanced Technology Attachment (S-ATA) protocol in accordance with the Serial ATA 1.0a Specification (published Feb. 4, 2003), a Fibre Channel protocol, or can be coupled to system 500 according to other protocols in other embodiments.

Embodiments may be implemented in code and may be stored on a computer readable medium such as a storage medium along with instructions, which can be used to program a system to execute the instructions. The storage medium may include, but is not limited to, any type of disk, including floppy disks, optical disks, compact disk read-only memories (CD-ROMs), compact disk rewritables (CD-WRs), and magneto-optical disks, semiconductor devices such as read-only memories (ROMs), random access memories (RAMS) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
waiting until processing capacity is available to perform a diagnostic on a non-volatile block of memory after a read error associated with the non-volatile block of memory is corrected.

2. The method of claim 1, including performing the diagnostic on the non-volatile block of memory.

3. The method of claim 2, including assigning the non-volatile block of memory to a bad state if the non-volatile block of memory fails the diagnostic or assigning the non-volatile block of memory to a good state if the non-volatile block of memory passes the diagnostic.

4. The method of claim 2, wherein the diagnostic includes writing known data patterns to the non-volatile block of memory.

5. The method of claim 1, including preventing the diagnostic on a non-volatile block of memory if a number of read errors exceeds a first threshold level or if the number of read errors is below a second threshold level.

6. The method of claim 1, including adding an identifier associated with the non-volatile block of memory to a list of blocks of memory in a suspect state.

7. A computer readable medium comprising instructions that, if executed, enable a processor-based system to:
change the state of an erasable block of memory to a suspect state to indicate the erasable block of memory is waiting for a diagnostic to be performed if a read error associated with the erasable block of memory is corrected.

8. The computer readable medium of claim 7, further comprising instructions that, if executed, cause the system to add an identifier of the erasable block of memory to a list of blocks in the suspect state.

9. The computer readable medium of claim 7, further comprising instructions that, if executed, cause the system to change the state of the erasable block of memory to a diagnostic state to indicate that the diagnostic is being performed on the erasable block of memory.

10. The computer readable medium of claim 9, further comprising instructions that, if executed, cause the system to add an identifier of the erasable block of memory to a list of blocks in the diagnostic state.

11. The computer readable medium of claim 9, further comprising instructions that, if executed, cause the system to assign the erasable block of memory to a bad state or a good state based on the result of the diagnostic.

12. The computer readable medium of claim 9, further comprising instructions that, if executed, cause the system to write a known data pattern to the erasable block of memory and read an output from the erasable block of memory.

13. The computer readable medium of claim 9, further comprising instructions that, if executed, cause the system to perform diagnostic commands by writing data with a weak signal.

14. The computer readable medium of claim 8, further comprising instructions that, if executed, cause the system to write the contents of the erasable block of memory to another erasable block of memory if a correctable read error occurs.

15. A device comprising:
a controller to perform a diagnostic on an erasable block of memory if a correctable read error occurs to data stored in the erasable block of memory.

16. The device of claim 15, wherein the controller is to wait until processing capacity is available to perform the diagnostic on the erasable block of memory.

17. The device of claim 16, wherein the controller is to select the erasable block of memory from a list of erasable blocks of memory in a suspect state.

18. The device of claim 15, wherein the controller is to assign the erasable block of memory to a bad state if the erasable block of memory fails the diagnostic or to assign the erasable block of memory to a good state if the erasable block of memory passes the diagnostic.

19. The device of claim 15, wherein the controller is to perform the diagnostic on the erasable block of memory if a number of correctable read errors exceed a threshold level.

20. The device of claim 15, wherein the controller is to assign the erasable block of memory to a bad state in response to a read error that is not correctable.

21. The device of claim 19, wherein the controller is to write the contents of the erasable block of memory to another erasable block of memory if the number of correctable read errors exceeds the threshold level.

22. The device of claim 15, wherein the erasable block of memory comprises a NAND based non-volatile storage.

23. A system comprising:
a processor to execute instructions;
a controller coupled to the processor, wherein the controller is to perform a diagnostic on a block of memory in a suspect state, wherein storage of non-diagnostic data in a block of memory in a suspect state is prohibited; and
a dynamic random access memory coupled to the processor.

24. The system of claim 23, wherein the controller is to wait until processing capacity is available to perform the diagnostic on the block of memory in the suspect state.

25. The system of claim 24, wherein the controller is to assign the block of memory to a bad state if the block of memory fails the diagnostic or to assign the block of memory to a good state if the block of memory passes the diagnostic.

26. The system of claim 23, wherein the controller is to perform the diagnostic on the block of memory if a number of read errors in the block of memory exceed a first threshold level.

27. The system of claim 26, wherein the controller is to assign the block of memory to a bad state if the number of read errors exceeds a second threshold level.

28. The system of claim 23, wherein the controller is to write the contents of the block of memory to another block of memory if a read error from the block of memory is corrected.

29. The system of claim 23, wherein the block of memory comprises a NAND based non-volatile storage.

30. The system of claim 23, wherein the suspect state corresponds to a time period after correction of a read error and prior to execution of the diagnostic on the block of memory.
